(19) United States
(12) Patent Application Publication
(10) Pub. No.: US 2025/0289360 A1
(43) Pub. Date: Sep. 18, 2025

(54) VEHICLE CONTROL APPARATUS AND METHOD THEREOF

(71) Applicants: Hyundai Motor Company, Seoul (KR); Kia Corporation, Seoul (KR)

(72) Inventors: Hui Won Shin, Seoul (KR); Seul Ki Jeon, Seoul (KR); Eung Hwan Kim, Seoul (KR)

(21) Appl. No.: 18/816,970

(22) Filed: Aug. 27, 2024

(30) Foreign Application Priority Data
Mar. 15, 2024 (KR) 10-2024-0036656

(51) Int. Cl. B60Q 1/14

(52) U.S. Cl. CPC B60Q 1/143; B60Q 2300/314

(57) ABSTRACT

A vehicle control apparatus and a method thereof are provided. The vehicle control apparatus applies a first stabilization process that reduces a fluctuation range of a front illumination value to calculate a correction value of the front illumination value, applies a second stabilization process that reduces a fluctuation range of an upper illumination value to the upper illumination value to calculate a correction value of the upper illumination value, calculates a final photosensitive brightness value, based on at least one of the following: a result value obtained by applying a predetermined first reflection ratio to the correction value of the front illumination value or a result value obtained by applying a predetermined second reflection ratio to the correction value of the upper illumination value, or any combination thereof, and controls a light source device of the vehicle, based on the final photosensitive brightness value.

### CROSS-REFERENCE TO RELATED APPLICATION

This application claims under 35 U.S.C. § 119(a) the benefit of Korean Patent Application No. 10-2024-0036656, filed in the Korean Intellectual Property Office on Mar. 15, 2024, the entire contents of which are incorporated herein by reference.

### BACKGROUND

### Technical Field

The present disclosure relates to a vehicle control apparatus and a method thereof, and more particularly, relates to technologies for measuring illumination outside a vehicle.

### Background

Recently, with the development of electronic technology in vehicles, technology for automatically controlling brightness of a display, switch lighting, mood lamps, or the like in the vehicle based on brightness outside the vehicle has been integrated into the vehicle.

In this regard, driving stability should be maintained even when the driving environment of the vehicle varies and cannot be predicted. Therefore, there is a need to quickly and automatically measure illumination outside the vehicle.

Existing technology measures brightness in front of the vehicle to determine illumination outside the vehicle. However, if the illumination outside the vehicle is determined on the basis of the brightness in front of the vehicle, it is difficult to distinguish brightness at night and it is greatly influenced by front objects (e.g., the color of a forward vehicle, the lighting of the forward vehicle, or the like).

Particularly, if the vehicle enters a tunnel or a parking lot, the significant difference between the illumination at the current position of the vehicle and the illumination in the tunnel or parking lot ahead makes it difficult to suitably adjust brightness of a display or lighting in the vehicle.

### SUMMARY

The present disclosure has been made to solve the above-mentioned problems occurring in the prior art while advantages achieved by the prior art are maintained intact.

An aspect of the present disclosure provides a vehicle control apparatus for measuring both of illumination in front of a vehicle and illumination above the vehicle to distinguish a difference in brightness according to whether there are street lights during nighttime driving and a method thereof.

Another aspect of the present disclosure provides a vehicle control apparatus for measuring both of illumination in front of a vehicle and illumination above the vehicle to determine illumination outside the vehicle with regard to an influence according to a color of a forward vehicle and whether the forward vehicle lights up and a method thereof.

Another aspect of the present disclosure provides a vehicle control apparatus for measuring both of illumination in front of a vehicle and illumination above the vehicle to determine illumination outside the vehicle with regard to a direction facing the front of the vehicle in a sunrise time zone or a sunset time zone and a method thereof.

Another aspect of the present disclosure provides a vehicle control apparatus for measuring both of illumination in front of a vehicle and illumination above the vehicle to determine illumination outside the vehicle with regard to a difference between illumination at a current position of the vehicle and illumination in a tunnel or a parking lot in front of the vehicle, when the vehicle enters the parking lot or the tunnel, and a method thereof.

Another aspect of the present disclosure provides a vehicle control apparatus for applying a variable weight to illumination in front of the vehicle and illumination above the vehicle to determine illumination outside the vehicle, depending on a driving situation including a speed of the vehicle and a gradient of the road ahead and a method thereof.

Another aspect of the present disclosure provides a vehicle control apparatus for determining a situation in which illumination outside a vehicle changes greatly, based on a difference between illumination in front of the vehicle and illumination above the vehicle and a method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a vehicle control apparatus may include a front illumination sensor that senses brightness in front of a vehicle, an upper illumination sensor that senses brightness above the vehicle, a memory storing a program instruction, and a processor configured to execute the program instruction. The processor may calculate a correction value of a front illumination value by applying a first stabilization process that reduces a fluctuation range of the front illumination value measured based on the brightness in front of the vehicle, the brightness being sensed by the front illumination sensor; calculate a correction value of an upper illumination value by applying a second stabilization process that reduces a fluctuation range of the upper illumination value measured based on the brightness above the vehicle, the brightness being sensed by the upper illumination sensor; calculate a final photosensitive brightness value, based on at least one of the following: a result value obtained by applying a predetermined first reflection ratio to the correction value of the front illumination value, a result value obtained by applying a predetermined second reflection ratio to the correction value of the upper illumination value, or any combination thereof; and control a light source device of the vehicle, the light source device comprising at least one of a display of the vehicle, lighting inside the vehicle, or lighting outside the vehicle, or any combination thereof, based on the final photosensitive brightness value.

In an embodiment, the first stabilization process may include a process of calculating a correction value of a front illumination value at a specific time point, based on a result value obtained by applying a predetermined first weight to the front illumination value measured at the specific time point and a result value obtained by applying a predetermined second weight to a correction value of a front illumination value calculated before the specified time point. The second stabilization process may include a process of calculating a correction value of an upper illumination value at the specific time point, based on a result value obtained by applying a predetermined third weight to the upper illumination value measured at the specific time point and a result value obtained by applying a predetermined fourth weight to a correction value of an upper illumination value calculated before the specified time point.

In an embodiment, the processor may calculate the correction value of the front illumination value at the specific time point, while maintaining the sum of the first weight and the second weight as a total value of predetermined weights, and may calculate the correction value of the upper illumination value at the specific time point, while maintaining the sum of the third weight and the fourth weight as the total value of predetermined weights.

In an embodiment, the processor may calculate the final photosensitive brightness value, while maintaining the sum of the first reflection ratio and the second reflection ratio as a total value of predetermined reflection ratios.

In an embodiment, the first reflection ratio may include a first fixed reflection ratio, a ratio value of which is fixed for each specific situation including at least one of daytime driving, nighttime driving on a road with street lights on, nighttime driving on a road without street lights, driving in a tunnel, or driving in an indoor parking lot, or any combination thereof. The second reflection ratio may include a second fixed reflection ratio, a ratio value of which is fixed for each specific situation. The processor may calculate the final photosensitive brightness value, based on at least one of the following: a result value obtained by applying the first fixed reflection ratio to the correction value of the front illumination value or a result value obtained by applying the second fixed reflection ratio to the correction value of the upper illumination value, or any combination thereof.

In an embodiment, the first reflection ratio may include a first variable reflection ratio, a ratio value of which varies with a value of a specific variable including a speed of the vehicle, a distance between the vehicle and a front tunnel, a distance between the vehicle and a front indoor parking lot, or a gradient of a road ahead. The second reflection ratio may include a second variable reflection ratio, a ratio value of which varies with the value of the specific variable. The processor may calculate the final photosensitive brightness value, based on at least one of the following: a result value obtained by applying the first variable reflection ratio to the correction value of the front illumination value or a result value obtained by applying the second variable reflection ratio to the correction value of the upper illumination value, or any combination thereof.

In an embodiment, while the vehicle is traveling, if a difference between the brightness in front of the vehicle and the brightness above the vehicle is greater than a predetermined threshold, the processor may apply a first additional weight to the first stabilization process to increase a ratio of the front illumination value measured at the specific time point to the correction value of the front illumination value calculated before the specific time point or may apply a second additional weight to the second stabilization process to increase a ratio of the upper illumination value measured at the specific time point to the correction value of the upper illumination value calculated before the specific time point.

In an embodiment, while the vehicle is traveling, if a difference between the brightness in front of the vehicle and the brightness above the vehicle is greater than a predetermined threshold, the processor may apply at least one weight to any one of the first reflection ratio or the second reflection ratio.

In an embodiment, the processor may change at least one of the first stabilization process, the second stabilization process, the first reflection ratio, or the second reflection ratio, or any combination thereof, depending on a time zone, and may calculate the final photosensitive brightness value.

In an embodiment, the first reflection ratio may include a first variable reflection ratio, a ratio value of which varies with a value of a specific variable including a speed of the vehicle, a distance between the vehicle and a front tunnel, a distance between the vehicle and a front indoor parking lot, or a gradient of a road ahead. The second reflection ratio may include a second variable reflection ratio, a ratio value of which varies with the value of the specific variable. The processor may calculate the final photosensitive brightness value, based on at least one of the following: a result value obtained by applying the first variable reflection ratio to the correction value of the front illumination value or a result value obtained by applying the second variable reflection ratio to the correction value of the upper illumination value, or any combination thereof.

In an embodiment, the first reflection ratio may include a first fixed reflection ratio, a ratio value of which is fixed for each specific situation including at least one of daytime driving, nighttime driving on a road with street lights on, nighttime driving on a road without street lights, driving in a tunnel, or driving in an indoor parking lot, or any combination thereof, the second reflection ratio may include a second fixed reflection ratio, a ratio value of which is fixed for each specific situation. The processor may calculate the final photosensitive brightness value, based on at least one of the following: a result value obtained by applying the first fixed reflection ratio to the correction value of the front illumination value or a result value obtained by applying the second fixed reflection ratio to the correction value of the upper illumination value, or any combination thereof.

In an embodiment, the first stabilization process may include a process of calculating the correction value of the front illumination value, based on a simple moving average (SMA) technique for calculating an arithmetic mean value of front illumination values measured during a specific duration, or a process of calculating the correction value of the front illumination value, based on an exponential moving average (EMA) technique for assigning a greater weight to a front illumination value measured recently among the front illumination values measured during the specific duration and calculating an average value of the front illumination values measured during the specific duration. The second stabilization process may include a process of calculating the correction value of the upper illumination value, based on the SMA technique for calculating an arithmetic mean value of upper illumination values measured during the specific duration, or a process of calculating the correction value of the upper illumination value, based on the EMA technique for assigning a greater weight to an upper illumination value measured recently among the upper illumination values measured during the specific duration and calculating an average value of the upper illumination values measured during the specific duration.

According to another aspect of the present disclosure, a vehicle control method may include sensing, by a front illumination sensor, brightness in front of a vehicle; sensing, by an upper illumination sensor, brightness above the vehicle; calculating, by a processor, a correction value of a front illumination value by applying a first stabilization process that reduces a fluctuation range of the front illumination value measured based on the brightness in front of the vehicle, the brightness being sensed by the front illumination sensor; calculating, by a processor, a correction value of an upper illumination value by applying a second stabilization process that reduces a fluctuation range of the upper illumination value measured based on the brightness above the vehicle, the brightness being sensed by the upper illumination sensor; calculating, by the processor, a final photosensitive brightness value, based on at least one of the following: a result value obtained by applying a predetermined first reflection ratio to the correction value of the front illumination value or a result value obtained by applying a predetermined second reflection ratio to the correction value of the upper illumination value, or any combination thereof; and controlling, by the processor, a light source device of the vehicle, the light source device including at least one of a display of the vehicle, lighting inside the vehicle, or lighting outside the vehicle, or any combination thereof, based on the final photosensitive brightness value.

In the vehicle control method according to an embodiment, the applying of the first stabilization process that reduces the fluctuation range of the front illumination value measured based on the brightness in front of the vehicle, the brightness being sensed by the front illumination sensor, to the front illumination value to calculate the correction value of the front illumination value by the processor may include calculating, by the processor, a correction value of a front illumination value at a specific time point, based on a result value obtained by applying a predetermined first weight to the front illumination value measured at the specific time point and a result value obtained by applying a predetermined second weight to a correction value of a front illumination value calculated before the specified time point. The applying of the second stabilization process that reduces the fluctuation range of the upper illumination value measured based on the brightness above the vehicle, the brightness being sensed by the upper illumination sensor, to the upper illumination value to calculate the correction value of the upper illumination value by the processor may include calculating, by the processor, a correction value of an upper illumination value at the specific time point, based on a result value obtained by applying a predetermined third weight to the upper illumination value measured at the specific time point and a result value obtained by applying a predetermined fourth weight to a correction value of an upper illumination value calculated before the specified time point.

In the vehicle control method according to an embodiment, the calculating of the final photosensitive brightness value, based on the at least one of the result value obtained by applying the predetermined first reflection ratio to the correction value of the front illumination value or the result value obtained by applying the predetermined second reflection ratio to the correction value of the upper illumination value, or the any combination thereof signal by the processor may include calculating, by the processor, the final photosensitive brightness value, based on at least one of the following: a result value obtained by applying a first fixed reflection ratio to the correction value of the front illumination value or a result value obtained by applying a second fixed reflection ratio to the correction value of the upper illumination value, or any combination thereof. The first reflection ratio may include the first fixed reflection ratio, a ratio value of which is fixed for each specific situation including at least one of daytime driving, nighttime driving on a road with street lights on, nighttime driving on a road without street lights, driving in a tunnel, or driving in an indoor parking lot, or any combination thereof. The second reflection ratio may include the second fixed reflection ratio, a ratio value of which is fixed for each specific situation. In the vehicle control method according to an embodiment, the calculating of the final photosensitive brightness value, based on the at least one of the result value obtained by applying the predetermined first reflection ratio to the correction value of the front illumination value or the result value obtained by applying the predetermined second reflection ratio to the correction value of the upper illumination value, or the any combination thereof signal by the processor may include calculating, by the processor, the final photosensitive brightness value, based on at least one of the following: a result value obtained by applying a first variable reflection ratio to the correction value of the front illumination value or a result value obtained by applying a second variable reflection ratio to the correction value of the upper illumination value, or any combination thereof. The first reflection ratio may include the first variable reflection ratio, a ratio value of which varies with a value of a specific variable including a speed of the vehicle, a distance between the vehicle and a front tunnel, a distance between the vehicle and a front indoor parking lot, or a gradient of a road ahead. The second reflection ratio may include the second variable reflection ratio, a ratio value of which varies with the value of the specific variable.

In the vehicle control method according to an embodiment, the applying of the first stabilization process that reduces the fluctuation range of the front illumination value measured based on the brightness in front of the vehicle, the brightness being sensed by the front illumination sensor, to the front illumination value to calculate the correction value of the front illumination value by the processor may include applying, by the processor, a first additional weight to the first stabilization process to increase a ratio of the front illumination value measured at the specific time point to the correction value of the front illumination value calculated before the specific time point, if a difference between the brightness in front of the vehicle and the brightness above the vehicle is greater than a predetermined threshold, while the vehicle is traveling. The applying of the second stabilization process that reduces the fluctuation range of the upper illumination value measured based on the brightness above the vehicle, the brightness being sensed by the upper illumination sensor, to the upper illumination value to calculate the correction value of the upper illumination value by the processor may include applying, by the processor, a second additional weight to the second stabilization process to increase a ratio of the upper illumination value measured at the specific time point to the correction value of the upper illumination value calculated before the specific time point, if the difference between the brightness in front of the vehicle and the brightness above the vehicle is greater than the predetermined threshold, while the vehicle is traveling.

In the vehicle control method according to an embodiment, the calculating of the final photosensitive brightness value, based on the at least one of the result value obtained by applying the predetermined first reflection ratio to the correction value of the front illumination value or the result value obtained by applying the predetermined second reflection ratio to the correction value of the upper illumination value, or the any combination thereof signal by the processor may include applying, by the processor, at least one weight to any one of the first reflection ratio or the second reflection ratio, if a difference between the brightness in front of the vehicle and the brightness above the vehicle is greater than a predetermined threshold, while the vehicle traveling.

In the vehicle control method according to an embodiment, the calculating of the final photosensitive brightness value, based on the at least one of the result value obtained by applying the predetermined first reflection ratio to the correction value of the front illumination value or the result value obtained by applying the predetermined second reflection ratio to the correction value of the upper illumination value, or the any combination thereof signal by the processor may include changing, by the processor, at least one of the first stabilization process, the second stabilization process, the first reflection ratio, or the second reflection ratio, or any combination thereof, depending on a time zone, and calculating, by the processor, the final photosensitive brightness value.

In the vehicle control method according to an embodiment, the applying of the first stabilization process that reduces the fluctuation range of the front illumination value measured based on the brightness in front of the vehicle, the brightness being sensed by the front illumination sensor, to the front illumination value to calculate the correction value of the front illumination value by the processor may include calculating, by the processor, the correction value of the front illumination, based on a simple moving average (SMA) technique for calculating an arithmetic mean value of front illumination values measured during a specific duration, or calculating the correction value of the front illumination value, based on an exponential moving average (EMA) technique for assigning a greater weight to a front illumination value measured recently among the front illumination values measured during the specific duration and calculating an average value of the front illumination values measured during the specific duration. The applying of the second stabilization process that reduces the fluctuation range of the upper illumination value measured based on the brightness above the vehicle, the brightness being sensed by the upper illumination sensor, to the upper illumination value to calculate the correction value of the upper illumination value by the processor may include calculating, by the processor, the correction value of the upper illumination, based on the SMA technique for calculating an arithmetic mean value of upper illumination values measured during the specific duration, or calculating, by the processor, the correction value of the upper illumination value, based on the EMA technique for assigning a greater weight to an upper illumination value measured recently among the upper illumination values measured during the specific duration and calculating an average value of the upper illumination values measured during the specific duration.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a vehicle control apparatus according to an embodiment of the present disclosure;

FIG. 2 is a drawing illustrating an example of a range of an angle of view capable of being detected by a front illumination sensor and an upper illumination sensor, in a vehicle control apparatus according to an embodiment of the present disclosure;

FIG. 3 is a block diagram illustrating an example of applying a stabilization process and a fixed reflection ratio to an illumination value to calculate final photosensitive brightness, in a vehicle control apparatus according to an embodiment of the present disclosure;

FIG. 4 is a drawing illustrating an example of a change in brightness in front of a vehicle and a change in brightness above the vehicle, which are detected while the vehicle performs nighttime driving on a road with street lights on, in a vehicle control apparatus according to an embodiment of the present disclosure;

FIG. 5 is a block diagram illustrating an example of applying a stabilization process and a variable reflection ratio to an illumination value to calculate final photosensitive brightness, in a vehicle control apparatus according to an embodiment of the present disclosure;

FIG. 6 is a graph illustrating an example of applying a variable reflection ratio depending on a vehicle speed, in a vehicle control apparatus according to an embodiment of the present disclosure;

FIG. 7 is a block diagram illustrating an example of applying an additional weight depending on a difference between brightness in front of a vehicle and brightness above the vehicle to calculate final photosensitive brightness, in a vehicle control apparatus according to an embodiment of the present disclosure;

FIG. 8 is a flowchart for describing a vehicle control apparatus or a vehicle control method according to an embodiment of the present disclosure; and

FIG. 9 illustrates a computing system associated with a vehicle control apparatus or a vehicle control method according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical component is designated by the identical numerals even when they are displayed on other drawings. In addition, a detailed description of well-known features or functions will be ruled out in order not to unnecessarily obscure the gist of the present disclosure.

In describing components of exemplary embodiments of the present disclosure, the terms first, second, A, B, (a), (b), and the like may be used herein. These terms are only used to distinguish one component from another component, but do not limit the corresponding components irrespective of the order or priority of the corresponding components. Particularly, the expression “at least one of A, B, or C, or any combination thereof” may include “A”, “B”, or “C”, or “AB”, “BC”, “AC”, or “ABC”, which is a combination thereof.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

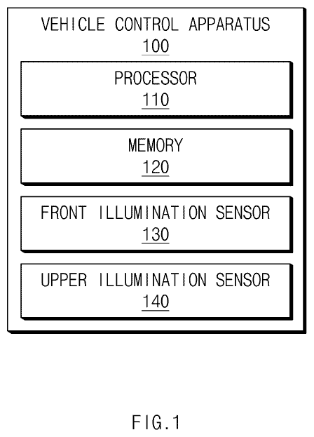

Hereinafter, embodiments of the present disclosure will be described in detail with reference to FIGS. 1 to 9.

FIG. 1 is a block diagram illustrating a vehicle control apparatus according to an embodiment of the present disclosure.

Referring to FIG. 1, a vehicle control apparatus 100 according to an embodiment of the present disclosure may be implemented in a vehicle. In this case, the vehicle control apparatus 100 may be integrally configured with control units in the vehicle or may be implemented as a separate device to be connected with the control units of the vehicle by a separate connection means.

According to an embodiment, the vehicle control apparatus 100 may include a processor 110, a memory 120, a front illumination sensor 130, and an upper illumination sensor 140. The components of the vehicle control apparatus 100, which are shown in FIG. 1, are illustrative, and embodiments of the present disclosure are not limited thereto. For example, the vehicle control apparatus 100 may further include components which are not shown in FIG. 1.

According to an embodiment, the memory 120 may store a command or data. For example, the memory 120 may store one instruction or two or more instructions, when executed by the processor 110, causing the vehicle control apparatus 100 to perform various operations.

According to an embodiment, the memory 120 and the processor 110 may be implemented as one chipset and may store various pieces of information associated with the vehicle control apparatus 100. For example, the memory 120 may store information about an operation history of the processor 110. As a detailed example, a front illumination value measured by the front illumination sensor 130 and an upper illumination value measured by the upper illumination sensor 140 may be stored in the memory 120.

According to an embodiment, the memory 120 may include a non-volatile memory (e.g., a read only memory (ROM)) and a volatile memory (e.g., a random access memory (RAM)).

According to an embodiment, the front illumination sensor 130 may sense brightness in front of the vehicle and the upper illumination sensor 140 may sense brightness above the vehicle.

According to an embodiment, the front illumination sensor 130 or the upper illumination sensor 140 may include one or more sensors.

According to an embodiment, the front illumination sensor 130 or the upper illumination sensor 140 may be attached to different positions of the vehicle. For example, the front illumination sensor 130 or the upper illumination sensor 140 may face one or more different directions. As a detailed example, the front illumination sensor 130 may be attached to the front, sides, rear, or roof of the vehicle to be face forward, while the upper illumination sensor 140 may be attached to the front, sides, rear, or roof of the vehicle to face upward.

According to an embodiment, the front illumination sensor 130 or the upper illumination sensor 140 may be attached to the same position of the vehicle to face different directions. For example, the front illumination sensor 130 or the upper illumination sensor 140 may be attached to an upper end of a front glass of the vehicle, and the front illumination sensor 130 may be attached to face forward and the upper illumination sensor 140 may be attached to face upward.

According to an embodiment, the front illumination sensor 130 or the upper illumination sensor 140 may sense brightness within a specific range of the angle of view. Herein, the specific range may be variously set according to a type of a sensor, a purpose of the sensor, or the like. In detail, the front illumination sensor 130 or the upper illumination sensor 140 may sense brightness for an angle of view of about 30 degrees.

According to an embodiment, the processor 110 may measure illumination based on the brightness of the vehicle, which is sensed by the illumination sensor. The processor 110 may obtain data for brightness sensed at a very fast speed from the illumination sensor. For example, the processor 110 may obtain raw data for brightness sensed at a speed of 40 ms to 50 ms from the illumination sensor. Herein, the raw data may include data in a raw state.

Because the raw data has a large fluctuation in value, the processor 110 may apply a stabilization process to the raw data to calculate a stabilized correction value. For example, the stabilization process may include a process of reducing a fluctuation range of the measured illumination value. The processor 110 may then stably control the brightness of a light source device of the vehicle based on the stabilized correction value.

According to an embodiment, the stabilization process may include a process of increasing stability and decreasing real time or a process of decreasing stability and increasing real time. The more the raw data is stabilized, the more the stability of the raw data may increase and the more the real time of the raw data may decrease. The real time may refer to a degree to which the raw data is reflected. For example, as the real time increases, a rate at which the raw data is reflected in the stabilized correction value may increase. In other words, the stability and the real time may have a trade-off relationship therebetween.

According to an embodiment, if applying a stabilization process with large real time compared to stability to the illumination value to calculate a correction value of the illumination value, the processor 110 may calculate a correction value of an illumination value in which a ratio of the brightness value sensed by the illumination sensor is large.

According to an embodiment, the stabilization process may include various processing methods, such as a stabilization processing method using a stabilization filter and a stabilization processing method using a moving average.

According to an embodiment, the processor 110 may apply a stabilization process using a stabilization filter to the illumination value measured by the illumination sensor. For example, the processor 110 may apply the stabilization process, which uses a low pass filter, to the illumination value measured by the illumination sensor. As a detailed example, the processor 110 may apply a stabilization process using a PT1 filter to the illumination value.

According to an embodiment, the stabilization process using the low pass filter may be used to calculate a correction value of a stabilized illumination value, based on Equation 1 below.

$${Y}_{m} = {Y}_{( m - 1 )} + Factor \times \{ {X}_{m} - {Y}_{( m - 1 )} \} \qquad [ Equation 1 ]$$

According to an embodiment, in Equation 1 above, Yₘ may refer to the correction value of the illumination value to which the stabilization filter is applied, Xₘ may refer to the illumination value measured by the illumination sensor (or the output illumination value of the illumination sensor), and Factor may refer to the weight. Hereinafter, Factor may have the value greater than or equal to 0 and less than or equal to 1 and may have the value greater than or equal to 0% and less than or equal to 100%.

According to an embodiment, Equation 1 above may be organized into Equation 2 below.

$${Y}_{m} = Factor \times {X}_{m} + ( 1 - Factor ) \times {Y}_{( m - 1 )} \qquad [ Equation 2 ]$$

Referring to Equation 1 or 2 above according to an embodiment, as Factor is large, the reflection ratio of Xₘ included in Yₘ may be large. Thus, as Factor is large, a ratio of the illumination value measured by the illumination sensor, which is reflected in the correction value of the illumination value, may increase.

According to an embodiment, the processor 110 may apply the stabilization process, which uses the moving average, to the illumination value measured by the illumination sensor.

For example, the processor 110 may apply the stabilization process, which uses a simple moving average (SMA) technique, to the illumination value measured by the illumination sensor. The SMA technique may include a technique for calculating an arithmetic average value of illumination values measured during a specific duration.

For example, the processor 110 may apply the stabilization process using an exponential moving average (EMA) technique, to the illumination value measured by the illumination sensor. The EMA technique may involve assigning a greater weight to an illumination value measured recently among the front illumination values measured during the specific duration and then calculating an average value of the illumination values measured during that duration.

According to an embodiment, the stabilization process using the SMA technique may be used to calculate a correction value of a stabilized illumination value based on Equation 3 below.

$${Y}_{m} = \frac{1}{n} {\sum }_{i = 0}^{n - 1} {X}_{( m - i )} \qquad [ Equation 3 ]$$

According to an embodiment, in Equation 3 above, Yₘ may refer to the correction value of the illumination value to which the stabilization filter is applied, and X₍ₘ₋ᵢ₎ may refer to the illumination value measured by the illumination sensor (or the output illumination value of the illumination sensor).

According to an embodiment, Yₘ of Equation 3 above may be calculated as an average value if an illumination value of Xₘ, X₍ₘ₋₁₎, . . . , Xₘ₋₍ₙ₋ᵢ₎ is input.

Referring to Equation 3 above, according to an embodiment, the stabilization process using the SMA technique may be used to calculate an average value of n illumination values as the correction value of the illumination value to which the stabilization filter is applied. If a new illumination value is input, the oldest illumination value may be deleted. The smaller the n value, the greater the proportion of the illumination value measured by the illumination sensor may increase.

According to an embodiment, the stabilization process using the EMA technique may be used to calculate a correction value of a stabilized illumination value, based on Equation 4 below.

$${Y}_{m} = ( \frac{n - 1}{n} \times {Y}_{m - 1} ) + ( \frac{1}{n} \times {X}_{m} ) \qquad [ Equation 4 ]$$

According to an embodiment, in Equation 4 above, Yₘ may refer to the correction value of the illumination value to which the stabilization filter is applied, and Xₘ may refer to the illumination value measured by the illumination sensor (or the output illumination value of the illumination sensor).

Referring to Equation 4 above according to an embodiment, the stabilization process using the EMA technique may be used to add a correction value Yₘ₋₁ of a previous illumination value and a new illumination value Xₘ at a ratio according to the n value to calculate the correction value of the illumination value to which the stabilization filter is applied.

According to an embodiment, in the stabilization process using the EMA technique, the smaller the n value, the more the proportion of the illumination value measured by the illumination sensor may increase.

According to an embodiment, in the stabilization process using the EMA technique, previous illumination values may fail to be removed and the influence on the correction value of the illumination value may decrease exponentially.

According to an embodiment, the processor 110 may apply a first stabilization process that reduces a fluctuation range of a front illumination value measured based on brightness in front of the vehicle, which is sensed by the front illumination sensor 130, to the front illumination value to calculate a correction value of the front illumination value.

According to an embodiment, the first stabilization process may include calculating a correction value of a front illumination value at a specific time point. This calculation is based on a result value obtained by applying a predetermined first weight to the front illumination value measured at the specific time point and a result value obtained by applying a predetermined second weight to the correction value of a front illumination value calculated prior to the specified time point.

For example, the first stabilization process may include the stabilization process using the low pass filter and may be used to calculate the correction value of the front illumination value at the specific time based on Equation 1 or 2 above. In this case, the predetermined first weight may refer to Factor, and the predetermined second weight may refer to (1−Factor).

As a detailed example, the processor 110 may add the result value obtained by applying the predetermined first weight Factor to the front illumination value Xₘ measured at the specific time point m and the result value obtained by applying the predetermined second weight (1−Factor) to the correction value Y₍ₘ₋₁₎ of the front illumination value calculated before (m−1) the specific time point to calculate the correction value Yₘ of the front illumination value at the specific time point.

According to an embodiment, the processor 110 may calculate the correction value of the front illumination value at the specific time point, while maintaining the sum of the first weight and the second weight as a total value of the predetermined weights.

For example, the total value of the predetermined weights may be set to 1 or 100%. In detail, if the first weight is set to 0.3, the second weight may be set to 0.7. If the first weight is set to 0.5, the second weight may be set to 0.5. For another example, if the first weight is set to 20%, the second weight may be set to 80%.

According to an embodiment, the processor 110 may apply a second stabilization process that reduces a fluctuation range of an upper illumination value measured based on brightness above the vehicle, which is sensed by the upper illumination sensor 140, to the upper illumination value to calculate a correction value of the upper illumination value.

According to an embodiment, the second stabilization process may be used to calculate a correction value for an upper illumination value at the specific time point. This calculation is based on a result value obtained by applying a predetermined third weight to the upper illumination value measured at the specific time point and a result value obtained by applying a predetermined fourth weight to a correction value of an upper illumination value calculated prior to the specified time point.

For example, the second stabilization process may include the stabilization process using the low pass filter and may be used to calculate the correction value of the upper illumination value at the specific time based on Equation 1 or 2 above. In this case, the predetermined third weight may refer to Factor, and the predetermined fourth weight may refer to (1−Factor).

As a detailed example, the processor 110 may add the result value obtained by applying the predetermined third weight Factor to the upper illumination value Xₘ measured at the specific time point m and the result value obtained by applying the predetermined fourth weight (1−Factor) to the correction value Y₍ₘ₋₁₎ of the upper illumination value calculated before (m−1) the specific time point to calculate the correction value Yₘ of the upper illumination value at the specific time point.

According to an embodiment, the processor 110 may calculate the correction value of the upper illumination value at the specific time point, while maintaining the sum of the third weight and the fourth weight as a total value of the predetermined weights.

For example, the total value of the predetermined weights may be set to 1 or 100%. In detail, if the third weight is set to 0.3, the fourth weight may be set to 0.7. If the third weight is set to 0.5, the fourth weight being in be set to 0.5. For another example, if the third weight is set to 20%, the fourth weight may be set to 80%.

The example in which the first stabilization process and the second stabilization process are used to calculate the correction value of the illumination value at the specific time point based on Equation 1 or 2 above is merely an example. The first stabilization process or the second stabilization process may also include the stabilization process using the low pass filter.

Thus, the first weight, the second weight, the third weight, and the fourth weight described in the first stabilization process and the second stabilization process may be the same value or different values. In other words, Factor corresponding to the first weight applied to the first stabilization process and Factor corresponding to the third weight applied to the second stabilization process may have different values.

According to an embodiment, the first stabilization process may include a process of calculating a correction value of a front illumination value, based on the SMA technique for calculating an arithmetic mean value of front illumination values measured during a specific duration.

For example, the processor 110 may calculate an arithmetic mean value of n front illumination values measured during the specific duration as a correction value of a front illumination value to which the stabilization filter is applied, with reference to Equation 3 above.

According to an embodiment, the first stabilization process may include a process of calculating a correction value of a front illumination value, based on the EMA technique for assigning a greater weight to a front illumination value measured recently among the front illumination values measured during the specific duration and then calculating an average value of the front illumination values measured during the specific duration.

For example, referring to Equation 4 above, the processor 110 may add a correction value Yₘ₋₁ of a previous front illumination value and a new front illumination value Xₘ at a ratio according to the n value to calculate the correction value of the front illumination value to which the stabilization filter is applied.

According to an embodiment, the second stabilization process may include a process of calculating a correction value of an upper illumination value, based on the SMA technique for calculating an arithmetic mean value of upper illumination values measured during the specific duration.

For example, the processor 110 may calculate an arithmetic mean value of upper illumination values measured during the specific duration as a correction value of an upper illumination value to which the stabilization filter is applied, with reference to Equation 3 above.

According to an embodiment, the second stabilization process may include calculating a correction value of an upper illumination value, based on the EMA technique for assigning a greater weight to an upper illumination value measured recently among the upper illumination values measured during the specific duration and then calculating an average value of the upper illumination values measured during that duration.

For example, referring to Equation 4 above, the processor 110 may add a correction value Yₘ₋₁ of a previous upper illumination value and a new upper illumination value Xₘ at a ratio according to the n value to calculate the correction value of the upper illumination value to which the stabilization filter is applied, with reference to Equation 4 above.

According to an embodiment, the processor 110 may calculate a final photosensitive brightness value, based on at least one of the following: a result value obtained by applying a predetermined first reflection ratio to the correction value of the front illumination value or a result value obtained by applying a predetermined second reflection ratio to the correction value of the upper illumination value, or any combination thereof.

According to an embodiment, the processor 110 may calculate the sum of a result value obtained by multiplying the correction value of the front illumination value by the predetermined first reflection ratio and a result value obtained by multiplying the correction value of the upper illumination value by the predetermined second reflection ratio as the final photosensitive brightness value.

According to an embodiment, the processor 110 may calculate the final photosensitive brightness, while maintaining the sum of the first reflection ratio and the second reflection ratio as a total value of predetermined reflection ratios.

For example, the total value of the predetermined reflection ratios may be set to 1 or 100%. In detail, if the first reflection ratio is set to 0.3, the second reflection ratio may be set to 0.7. If the first reflection ratio is set to 0.5, the second reflection ratio be set to 0.5. For another example, if the first reflection ratio is set to 20%, the second reflection ratio may be set to 80%.

According to an embodiment, the first reflection ratio may refer to a ratio at which brightness in front of the vehicle is reflected when determining the final photosensitive brightness. The second reflection ratio may refer to the ratio at which brightness above the vehicle is reflected when determining the final photosensitive brightness.

For example, if the brightness in front of the vehicle is reflected by 30% and the brightness above the vehicle is reflected by 70% to calculate the final photosensitive brightness, the processor 110 may calculate the sum of a result value obtained by multiplying the correction value of the front illumination value by the first reflection ratio of 0.3 and a result value obtained by multiplying the correction value of the upper illumination value by the second reflection ratio of 0.7 as the final photosensitive brightness.

According to an embodiment, the processor 110 may control a light source device of the vehicle, which includes at least one of a display of the vehicle, lighting inside the vehicle, or lighting outside the vehicle, or any combination thereof, based on the final photosensitive brightness value.

For example, the display of the vehicle may include at least one of a cluster, a head up display (HUD), a center Information display (CID), a co-driver display (CDD), a side mirror display, or a rear seat entertainment display, or any combination thereof.

For example, the lighting inside the vehicle may include ambient lights for creating the atmosphere of the vehicle and providing passengers with a comfortable and luxurious feeling, room lights for illuminating the entire interior of the vehicle, spotlights for directly illuminating a specific area or object, switch lights installed in switches, door lights, sun visor mirror lights, a lighting control panel, courtesy lights for illuminating the area beneath the feet of a person who rides and alights from the vehicle, or the like.

For example, the lighting outside the vehicle may include headlights for illuminating the front of the vehicle, a reverse light which is turned on when the transmission lever is switched to reverse gear, fog lamps for increasing visibility in environments where it is difficult to ensure forward visibility due to fog, snow, or rain, brake lights that operate when the driver presses the brake pedal, turn signals used to indicate a direction the vehicle is turning, daytime running lights which are turned on in the front of the vehicle to make it easily recognizable to other drivers and pedestrians during the day, a license plate light for illuminating the license plate, or the like.

For example, the processor 110 may increase brightness of the lighting inside the vehicle, if the brightness outside the vehicle is dark, and may decrease the brightness of the lighting inside the vehicle, if the brightness outside the vehicle is bright.

According to an embodiment, the first reflection ratio or the second reflection ratio may be set to a fixed ratio for each specific situation, including at least one of daytime driving, nighttime driving on a road with street lights on, nighttime driving on a road without street lights, driving in a tunnel, or driving in an indoor parking lot, or any combination thereof.

For example, the first reflection ratio may include a first fixed reflection ratio, a ratio value of which is fixed for each specific situation, and the second reflection ratio may include a second fixed reflection ratio, a ratio value of which is fixed for each specific situation.

According to an embodiment, the first fixed reflection ratio and the second fixed reflection ratio may be set to the same value or to different values. For example, the sum of the first fixed reflection ratio and the second fixed reflection ratio may be maintained as a total value of predetermined reflection ratios.

According to an embodiment, the processor 110 may calculate a final photosensitive brightness value based on at least one of the following: a result value obtained by applying the first fixed reflection ratio to the correction value of the front illumination value or a result value obtained by applying the second fixed reflection ratio to the correction value of the upper illumination value, or any combination thereof.

According to an embodiment, the processor 110 may add a result obtained by multiplying the correction value of the front illumination value by the first fixed reflection ratio and a result value obtained by multiplying the correction value of the upper illumination value by the second fixed reflection ratio to calculate the final photosensitive brightness value.

According to an embodiment, the processor 110 may apply a fixed reflection ratio set for each specific situation described above to the correction value of the illumination value.

For example, if the vehicle performs nighttime driving on a road with street lights on, compared with that the brightness in front of the vehicle is detected to be dark, the brightness above the vehicle may be detected to be bright by light of the street lights. At this time, the brightness outside the vehicle may be greater than brightness sensed by only the front illumination sensor 130. In this case, the processor 110 may assign a greater proportion to the brightness above the vehicle than the brightness in front of the vehicle to calculate the final photosensitive brightness value.

Thus, the second fixed reflection ratio may be set to be greater than the first fixed reflection ratio if the vehicle performs nighttime driving on a road with street lights, than if the vehicle performs nighttime driving on a road without street lights. For example, if the vehicle performs nighttime driving of a road with street lights, the processor 110 may add a result obtained by multiplying the correction value of the front illumination value by the first fixed reflection ratio of 0.3 and a result value obtained by multiplying the correction value of the upper illumination value by the second fixed reflection ratio of 0.7 to calculate the final photosensitive brightness value.

Likewise, if the vehicle drives in a tunnel, brightness above the vehicle may be detected to be brighter by lighting in the tunnel than that brightness in front of the vehicle is detected to be dark. In this case, the processor 110 may assign a greater proportion to the brightness above the vehicle than to the brightness in front of the vehicle to calculate the final photosensitive brightness value.

For another example, if the vehicle performs nighttime driving, brightness in front of the vehicle may be detected to be bright due to the influence of tail lights of a forward vehicle. In this case, that reduces the influence of the tail lights of the forward vehicle, the processor 110 may assign a greater proportion to the brightness above the vehicle than the brightness in front of the vehicle to calculate the final photosensitive brightness value.

Other than the above-mentioned example, the processor 110 may calculate the final photosensitive brightness using the fixed reflection ratio set for each of various situations.

According to an embodiment, the first reflection ratio or the second reflection ratio may be set to a variable reflection ratio, a ratio value of which varies with a value of a specific variable including a speed of the vehicle, a distance between the vehicle and a front tunnel, a distance between the vehicle and a front indoor parking lot, or a gradient of a road ahead.

For example, the first reflection ratio may include a first variable reflection ratio, a ratio value of which varies with a value of the specific variable, and the second reflection ratio may include a second variable reflection ratio, a ratio value of which varies with a value of the specific variable.

According to an embodiment, the first variable reflection ratio and the second variable reflection ratio may be set to the same value or to different values. For example, the sumof the first variable reflection ratio and the second variable reflection ratio may be maintained as a total value of predetermined reflection ratios.

According to an embodiment, the processor 110 may calculate the final photosensitive brightness value based on at least one of the following: a result value obtained by applying the first variable reflection ratio to the correction value of the front illumination value, a result value obtained by applying the second variable reflection ratio to the correction value of the upper illumination value, or any combination thereof.

According to an embodiment, the processor 110 may add a result value obtained by multiplying the correction value of the front illumination value by the first variable reflection ratio and a result value obtained by multiplying the correction value of the upper illumination value by the second variable reflection ratio to calculate the final photosensitive brightness value.

According to an embodiment, the processor 110 may apply a variable reflection ratio set for each specific situation described above to the correction value of the illumination value.

For example, if the specific variable is a speed of the vehicle and if the speed of the vehicle is greater than or equal to a threshold speed, the processor 110 may assign a greater proportion to brightness in front of the vehicle than brightness above the vehicle to calculate the final photosensitive brightness. As a detailed example, the processor 110 may assign a greater proportion to the correction value of the front illumination value than the correction value of the upper illumination value as the speed of the vehicle is large to calculate the final photosensitive brightness.

For another example, if the specific variable is the distance from the current position of the vehicle to a front tunnel (or a front indoor parking lot), the processor 110 may need to quickly reflect illumination of the front tunnel (or the front indoor parking lot) when the vehicle enters it. Thus, the processor 110 may assign a greater proportion to the correction value of the front illumination value than to the correction value of the upper illumination value as the distance from the current position of the vehicle to the front tunnel (or the front indoor parking lot) decreases, in order to calculate the final photosensitive brightness.

For another example, if the specific variable is a gradient of the road ahead, the processor 110 may differently apply reflection ratios of the correction value of the front illumination value and the correction value of the upper illumination value depending to the gradient of the road ahead.

For example, if the vehicle is driving uphill during daytime, the front of the vehicle may face the sun light. In this case, the brightness sensed by the front illumination sensor 130 may be greater than the brightness sensed by the upper illumination sensor 140. Thus, the processor 110 may assign a greater proportion to the correction value of the upper illumination value than the correction value of the front illumination value as the gradient of the road ahead is larger to calculate the final photosensitive brightness.

According to an embodiment, if the vehicle exits or enter a tunnel or a parking lot, the processor 110 may need to calculate the final photosensitive brightness value corresponding to brightness outside the vehicle, which varies rapidly.

For example, if the vehicle exits or enters the tunnel or the parking lot, the processor 110 may apply an additional weight to the stabilization process to increase real time of the measured illumination value. If the realtime increases, as a degree to which the raw data is reflected as it is increases, the processor 110 may quickly measure brightness which changes rapidly.

According to an embodiment, while the vehicle is traveling, if the difference between the brightness in front of the vehicle and the brightness above the vehicle is greater than a predetermined threshold, the processor 110 may apply a first additional weight to the first stabilization process to increase the ratio of the front illumination value measured at a specific time point to the correction value of the upper illumination value calculated before the specific time point.

For example, the processor 110 may apply the first additional weight for increasing real time of the measured front illumination value to the first stabilization process.

According to an embodiment, while the vehicle is traveling, if the difference between the brightness in front of the vehicle and the brightness above the vehicle is greater than the predetermined threshold, the processor 110 may apply a second additional weight to the second stabilization process to increase the ratio of the upper illumination value measured at the specific time point to the correction value of the upper illumination value calculated before the specific time point.

For example, the processor 110 may apply the second additional weight for increasing real time of the measured upper illumination value to the second stabilization process.

According to an embodiment, the threshold predetermined in conjunction with the difference between the brightness in front of the vehicle and the brightness above the vehicle may be set to a value capable of determining that external brightness changes rapidly as the vehicle exits and enters a tunnel or a parking lot. For example, the predetermined threshold may be set to 10,000 LUX.

According to an embodiment, if the difference between the brightness in front of the vehicle and the brightness above the vehicle is greater than the predetermined threshold, the processor 110 may determine that the vehicle exits and enters the tunnel or the parking lot.

According to an embodiment, the first additional weight and the second additional weight may be set to the same value or different values.

According to an embodiment, the processor 110 may apply an additional weight for increasing stability of an illumination value measured by the illumination sensor to the stabilization process. For example, the first additional weight and the second additional weight may be set to increase the stability of the measured illumination value. In other words, the first additional weight and the second additional weight may be set to increase the real time responsiveness or stability of the illumination value, depending on a situation.

According to an embodiment, while the vehicle is traveling, if the difference between the brightness in front of the vehicle and the brightness above the vehicle is greater than the predetermined threshold, the processor 110 may apply at least one weight to any one of the first reflection ratio or the second reflection ratio.

According to an embodiment, the processor 110 may apply a weight to any one of the first reflection ratio or the second reflection ratio. For example, if there is a need to increase the proportion of the front illumination value, the processor 110 may apply a weight to only the first reflection ratio. Conversely, if there is a need to increase the proportion of the upper illumination value, the processor 110 may apply a weight to only the second reflection ratio.

According to an embodiment, the first reflection ratio may refer to a ratio at which the correction value of the front illumination value is reflected in calculating the final photosensitive brightness, and the second reflection ratio may refer to a ratio at which the correction value of the upper illumination value is reflected in calculating the final photosensitive brightness.

For example, the weight applied to the first reflection ratio or the weight applied to the second reflection ratio may be to increase any one of the first reflection ratio or the second reflection ratio. The weight may be applied to only any one of the first reflection ratio or the second reflection ratio.

For example, if it is determined that external brightness changes rapidly as the vehicle exits and enters the tunnel or the parking lot, the processor 110 may apply the first weight to the first reflection ratio to increase a ratio of the correction value of the front illumination value to the correction value of the upper illumination value. In other words, the processor 110 may calculate the final photosensitive brightness around the brightness in front of the vehicle, thus quickly control the light source device of the vehicle although the vehicle enters the tunnel or the parking lot.

According to an embodiment, the processor 110 may change at least one of the first stabilization process, the second stabilization process, the first reflection ratio, or the second reflection ratio, or any combination thereof, depending on a time zone, and may calculate a final photosensitive brightness value.

For example, a difference between brightness inside the tunnel (or the indoor parking lot) and brightness outside the tunnel (or the indoor parking lot) may be large from sunrise to sunset, but a difference between brightness inside the tunnel (or the indoor parking lot) and brightness outside the tunnel (or the indoor parking lot) may not be large from sunset to sunrise. Thus, the processor 110 may apply different methods for calculating the final photosensitive brightness depending on the time of day.

According to an embodiment, the processor 110 may apply a variable reflection ratio to the correction value of the illumination value to calculate a final photosensitive brightness value, in the time zone from sunrise to sunset.

According to an embodiment, the processor 110 may calculate a final photosensitive brightness value, based on at least one of the following: a result value obtained by applying the first variable reflection ratio to the correction value of the front illumination value or a result value obtained by applying the second variable reflection ratio to the correction value of the upper illumination value, or any combination thereof, in the time zone from sunrise to sunset.

According to an embodiment, the processor 110 may apply a fixed reflection ratio to the correction value of the illumination value to calculate a final photosensitive brightness value, in the time zone from sunset to sunrise.

According to an embodiment, the processor 110 may calculate a final photosensitive brightness value in the time zone from sunset to sunrise based on at least one of the following: a result value obtained by applying the first fixed reflection ratio to the correction value of the front illumination value or a result value obtained by applying the second fixed reflection ratio to the correction value of the upper illumination value, or any combination thereof.

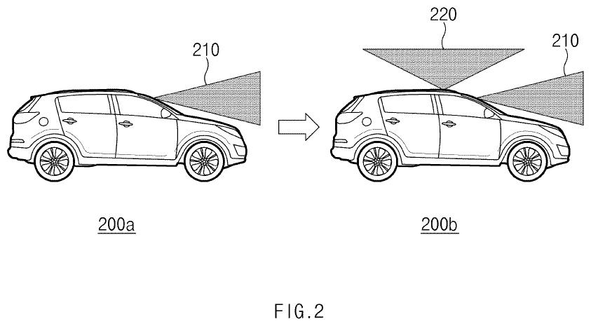

FIG. 2 is a drawing illustrating an example of a range of an angle of view capable of being detected by a front illumination sensor and an upper illumination sensor, in a vehicle control apparatus according to an embodiment of the present disclosure.

Referring to reference numeral 200a according to an embodiment, a vehicle equipped with only a front illumination sensor may detect only illumination in front of the vehicle.

For example, the front illumination sensor may sense illumination detected at a certain angle of view 210 in front of the vehicle.

According to an embodiment, if only the front illumination sensor is loaded into the vehicle, the vehicle control apparatus may determine brightness outside the vehicle depending on only brightness in front of the vehicle and may cause various problems below.

For example, the vehicle control apparatus may be influenced by brightness or a color of a front object, in determining brightness outside the vehicle. Herein, the front object may include a building, a forward vehicle, a road surface color, or the like.

For example, the vehicle control apparatus may be influenced by a direction in which the front of the vehicle faces the sun, at sunrise or sunset, in determining the brightness outside the vehicle.

For example, the vehicle control apparatus may have difficulty distinguishing brightness of a road during nighttime driving, in determining the brightness outside the vehicle.

As such, if only the front illumination sensor is loaded into the vehicle, because only the brightness at the certain angle of view 210 in front of the vehicle, a difference between the brightness at the certain angle of view 210 and actual brightness around the vehicle may be large.

Referring to reference numeral 200b according to an embodiment, a vehicle equipped with both a front illumination sensor and an upper illumination sensor may detect both of illumination in front of the vehicle and illumination above the vehicle.

For example, the front illumination sensor may sense illumination detected within a certain angle of view 210 in front of the vehicle, and the upper illumination sensor may sense illumination detected within a certain angle of view 220 above the vehicle.

According to an embodiment, if both the front illumination sensor and the upper illumination sensor are loaded into the vehicle, the vehicle control apparatus may determine brightness outside the vehicle with regard to brightness in front of the vehicle and brightness above the vehicle to obtain the following various advantages.

For example, the vehicle control apparatus may determine brightness outside the vehicle with regard to the brightness in front of the vehicle and the brightness above the vehicle, thus easily distinguishing brightness of the road during nighttime driving.

For example, the vehicle control apparatus may determine the brightness outside the vehicle with regard to the brightness in front of the vehicle and the brightness above the vehicle, thus being less influenced by a direction in which the front of the vehicle faces the sun at sunrise or sunset.

For example, the vehicle control apparatus may determine the brightness outside the vehicle with regard to the brightness in front of the vehicle and the brightness above the vehicle, thus being less influenced by a deviation of an illumination value which is generated between a light source and a light source, such as street lights of the road or lighting of the tunnel.

As such, if both the front illumination sensor and the upper illumination sensor are equipped into the vehicle, the vehicle control apparatus may determine the brightness outside the vehicle by considering both the brightness in front of the vehicle and the brightness above the vehicle, thus improving the accuracy of measuring the brightness outside the vehicle.

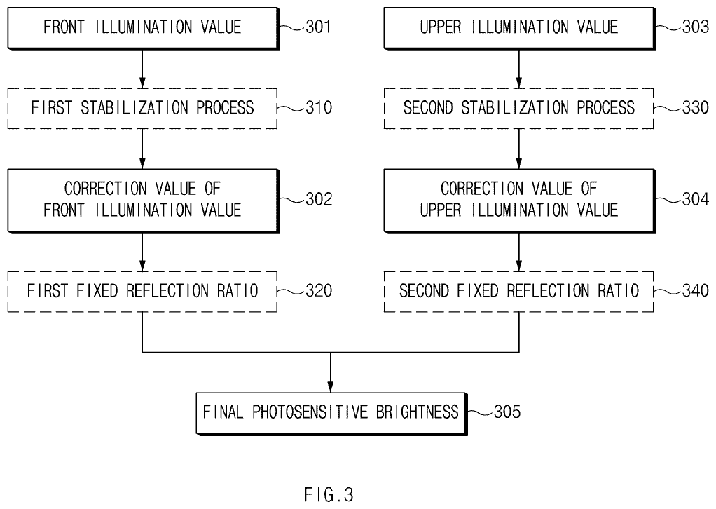

FIG. 3 is a block diagram illustrating an example of applying a stabilization process and a fixed reflection ratio to an illumination value to calculate final photosensitive brightness, in a vehicle control apparatus according to an embodiment of the present disclosure.

In a description of FIG. 3 according to an embodiment, an operation described as being performed by a vehicle control apparatus may be understood as being controlled by a processor 110 of a vehicle control apparatus 100 of FIG. 1.

For example, a stabilization process of FIG. 3 may include a stabilization process using a low pass filter, a stabilization process using a moving average, or a stabilization process using an exponential average.

According to an embodiment, the vehicle control apparatus may detect brightness in front of the vehicle by a front illumination sensor to measure a front illumination value 301.

According to an embodiment, the vehicle control apparatus may apply a first stabilization process 310 to the front illumination value 301 to calculate a correction value 302 of the front illumination value.

According to an embodiment, the vehicle control apparatus may calculate a result value obtained by applying a first fixed reflection ratio 320 to the correction value 302 of the front illumination value. For example, the vehicle control apparatus may calculate a result value obtained by multiplying the correction value 302 of the front illumination value by the first fixed reflection ratio 320.

According to an embodiment, the vehicle control apparatus may detect brightness above the vehicle by an upper illumination sensor to measure an upper illumination value 303.

According to an embodiment, the vehicle control apparatus may apply a second stabilization process 330 to the upper illumination value 303 to calculate a correction value 304 of the upper illumination value.

According to an embodiment, the vehicle control apparatus may calculate a result value obtained by applying a second fixed reflection ratio 340 to the correction value 304 of the upper illumination value. For example, the vehicle control apparatus may calculate a result value obtained by multiplying the correction value 304 of the upper illumination value by the second fixed reflection ratio 340.

According to an embodiment, the first fixed reflection ratio 320 and the second fixed reflection ratio 340 may include a ratio with a fixed value for each specific situation.

For example, the specific situation may include at least one of daytime driving, nighttime driving on a road with street lights on, nighttime driving on a road without street lights, driving in a tunnel, or driving in an indoor parking lot, or any combination thereof.

According to an embodiment, the first fixed reflection ratio 320 and the second fixed reflection ratio 340 may be set to the same value or to different values. For example, the sum of the first fixed reflection ratio 320 and the second fixed reflection ratio 340 may be set to be maintained as a total value of predetermined reflection ratios.

According to an embodiment, the vehicle control apparatus may calculate the final photosensitive brightness 305, based on the result value obtained by applying the first fixed reflection ratio 320 to the correction value 302 of the front illumination value and the result value obtained by applying the second fixed reflection ratio 340 to the correction value 304 of the upper illumination value.

For example, the vehicle control apparatus may calculate the final photosensitive brightness 305 by multiplying the correction value 302 of the front illumination value by the first fixed reflection ratio 320 and the result value obtained by multiplying the correction value 304 of the upper illumination value by the second fixed reflection ratio 340.

Referring to FIG. 3 according to an embodiment, the vehicle control apparatus may calculate the final photosensitive brightness, using a fixed reflection ratio for changing proportions reflecting the front illumination value and the upper illumination value, for each specific situation.

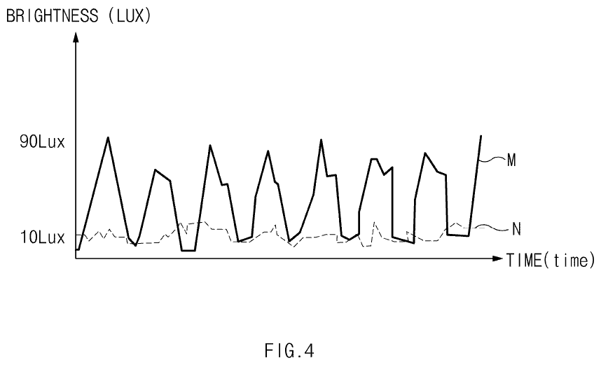

FIG. 4 is a drawing illustrating an example of a change in brightness in front of a vehicle and a change in brightness above the vehicle, which are detected while the vehicle performs nighttime driving on a road with street lights on, in a vehicle control apparatus according to an embodiment of the present disclosure.

Referring to FIG. 4 according to an embodiment, a change M in brightness above the vehicle and a change N in brightness in front of the vehicle, detected when the vehicle performs nighttime driving on a road with street lights, may be identified.

For example, whenever the vehicle passes between a street light and a street light, the change M in brightness above the vehicle may be detected to be large. If the vehicle control apparatus determines brightness outside the vehicle depending on only the brightness above the vehicle, it may be difficult for the vehicle control apparatus to suitably calculate final photosensitive brightness.

On the other hand, although the vehicle passes between a street light and a street light, the change N in brightness in front of the vehicle may be detected to be small.

Thus, if the vehicle performs nighttime driving on a road with street lights on, the vehicle control apparatus may consider both the brightness above the vehicle and the brightness in front of the vehicle, thus suitably calculating final photosensitive brightness.

For example, if the vehicle performs nighttime driving on the road with street lights on, the vehicle control apparatus may assign a greater proportion to the brightness in front of the vehicle than the brightness above the vehicle to determine brightness outside the vehicle, thus calculating more accurate final photosensitive brightness.

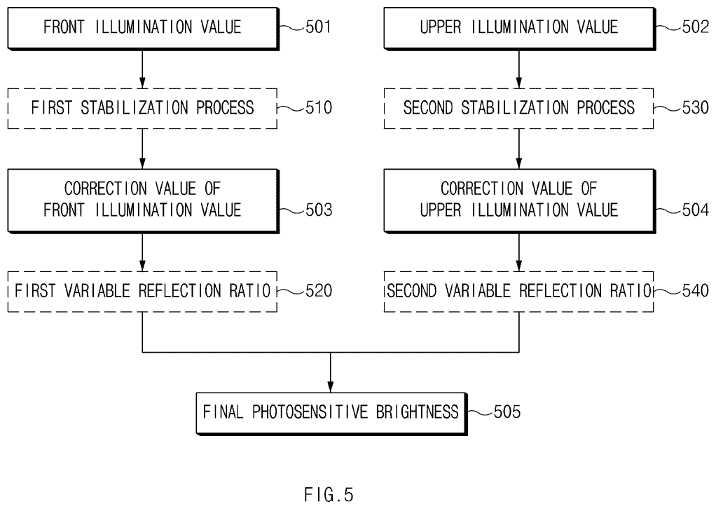

FIG. 5 is a block diagram illustrating an example of applying a stabilization process and a variable reflection ratio to an illumination value to calculate final photosensitive brightness, in a vehicle control apparatus according to an embodiment of the present disclosure.

In a description of FIG. 5 according to an embodiment, an operation described as being performed by a vehicle control apparatus may be understood as being controlled by a processor 110 of a vehicle control apparatus 100 of FIG. 1.

For example, a stabilization process of FIG. 5 may include a stabilization process using a low pass filter, a stabilization process using a moving average, or a stabilization process using an exponential average.

According to an embodiment, the vehicle control apparatus may detect brightness in front of the vehicle by a front illumination sensor to measure a front illumination value 501.

According to an embodiment, the vehicle control apparatus may apply a first stabilization process 510 to the front illumination value 501 to calculate a correction value 503 of the front illumination value.

According to an embodiment, the vehicle control apparatus may calculate a result value obtained by applying a first variable reflection ratio 520 to the correction value 503 of the front illumination value. For example, the vehicle control apparatus may calculate a result value obtained by multiplying the correction value 503 of the front illumination value by the first variable reflection ratio 520.

According to an embodiment, the vehicle control apparatus may detect brightness above the vehicle by an upper illumination sensor to measure an upper illumination value 502.

According to an embodiment, the vehicle control apparatus may apply a second stabilization process 530 to the upper illumination value 502 to calculate a correction value 504 of the upper illumination value.

According to an embodiment, the vehicle control apparatus may calculate a result value obtained by applying a second variable reflection ratio 540 to the correction value 504 of the upper illumination value. For example, the vehicle control apparatus may calculate a result value obtained by multiplying the correction value 504 of the upper illumination value by the second variable reflection ratio 540.

According to an embodiment, the first variable reflection ratio 520 and the second variable reflection ratio 540 may include a ratio, a ratio value of which varies with a value of a specific variable.

For example, the specific variable may include a speed of the vehicle, a distance between the vehicle and a front tunnel, a distance between the vehicle and a front indoor parking lot, or a gradient of a road ahead.

According to an embodiment, the first variable reflection ratio 520 and the second variable reflection ratio 540 may be set to the same value or to different values. For example, the sum of the first variable reflection ratio 520 and the second variable reflection ratio 540 may be set to be maintained as a total value of predetermined reflection ratios.

According to an embodiment, the vehicle control apparatus may calculate the final photosensitive brightness 505, based on the result value obtained by applying the first variable reflection ratio 520 to the correction value 503 of the front illumination value and the result value obtained by applying the second variable reflection ratio 540 to the correction value 504 of the upper illumination value.

For example, the vehicle control apparatus may calculate the final photosensitive brightness 505 by adding the result value obtained by multiplying the correction value 503 of the front illumination value by the first variable reflection ratio 520 and the result value obtained by multiplying the correction value 504 of the upper illumination value by the second variable reflection ratio 540.

Referring to FIG. 5 according to an embodiment, the vehicle control apparatus may calculate the final photosensitive brightness, using a variable reflection ratio for changing proportions reflecting the front illumination value and the upper illumination value depending on a value of a specific variable.

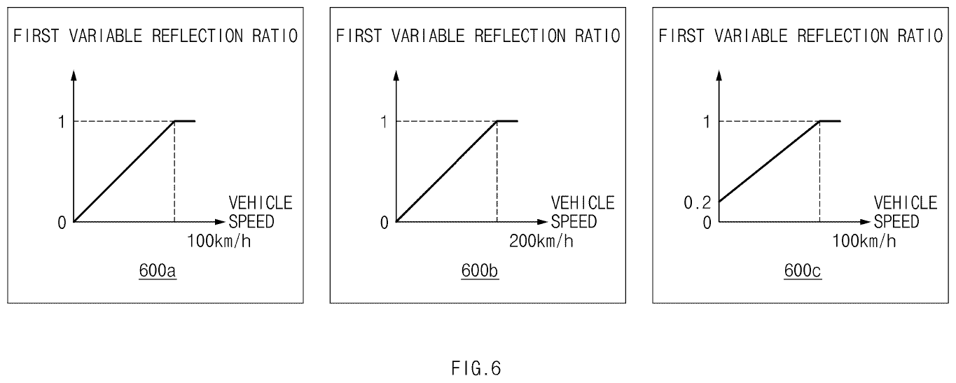

FIG. 6 is a graph illustrating an example of applying a variable reflection ratio depending on a vehicle speed, in a vehicle control apparatus according to an embodiment of the present disclosure.

Referring to reference numerals 600a to 600c according to an embodiment, a first variable ratio may be set to a value which is greater than or equal to 0 or is less than or equal to 1. The more the speed of the vehicle increases, the more the first variable ratio may increase.

For example, the vehicle control apparatus may assign a greater proportion to a front illumination value than an upper illumination value as the speed of the vehicle is large, thus calculating final photosensitive brightness.

Reference numeral 600a according to an embodiment may indicate an example in which the speed of the vehicle in the range of 0 km/h to 100 km/h corresponds to a first variable ratio in the range of 0 to 1.

For example, the first variable ratio may be set to 0, if the speed of the vehicle is 0 km/h, and the first variable ratio may be set to 1, if the speed of the vehicle is 100 km/h.

Reference numeral 600b according to an embodiment may indicate an example in which the speed of the vehicle in the range of 0 km/h to 200 km/h corresponds to the first variable ratio in the range of 0 to 1.

For example, the first variable ratio may be set to 0, if the speed of the vehicle is 0 km/h, and the first variable ratio may be set to 1, if the speed of the vehicle is 200 km/h.

Reference numeral 600c according to an embodiment may indicate an example in which the speed of the vehicle in the range of 0 km/h to 100 km/h corresponds to the first variable ratio in the range of 0.2 to 1.

For example, the first variable ratio may be set to 0.2, if the speed of the vehicle is 0 km/h, and the first variable ratio may be set to 1 if the speed of the vehicle is 100 km/h.

Referring to Reference numerals 600a to 600c according to an embodiment, the first variable reflection ratio may be variably matched with a specific variable.

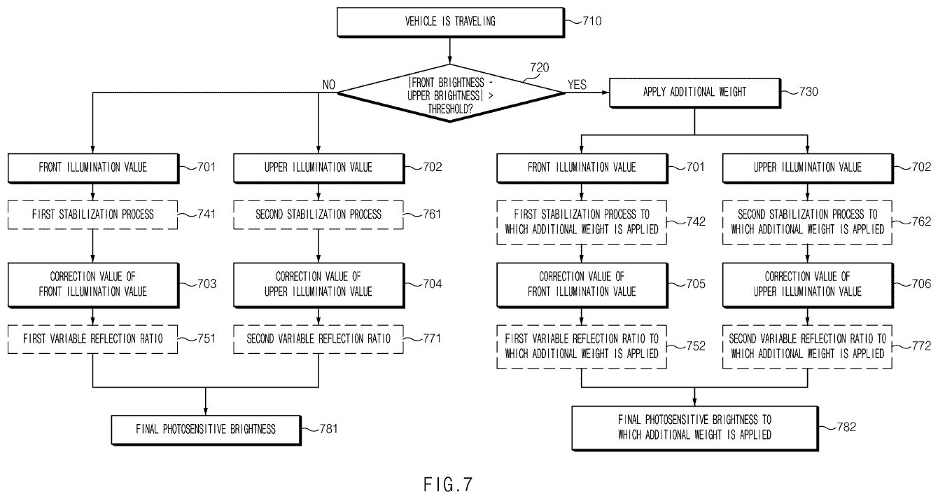

FIG. 7 is a block diagram illustrating an example of applying an additional weight depending on a difference between brightness in front of a vehicle and brightness above the vehicle to calculate final photosensitive brightness, in a vehicle control apparatus according to an embodiment of the present disclosure.

In a description of FIG. 7 according to an embodiment, an operation described as being performed by a vehicle control apparatus may be understood as being controlled by a processor 110 of a vehicle control apparatus 100 of FIG. 1.

For example, a stabilization process of FIG. 7 may include a stabilization process using a low pass filter, a stabilization process using a moving average, or a stabilization process using an exponential average.

According to an embodiment, if a vehicle is traveling (710), the vehicle control apparatus may determine whether a difference between brightness in front of the vehicle and brightness above the vehicle is greater than a predetermined threshold (720).

According to an embodiment, if the difference between the brightness in front of the vehicle and the brightness above the vehicle is not greater than the predetermined threshold, the vehicle control apparatus may calculate the final photosensitive brightness without applying an additional weight as follows.

For example, the vehicle control apparatus may detect brightness in front of the vehicle by a front illumination sensor to measure a front illumination value 701. The vehicle control apparatus may apply a first stabilization process 741 to the front illumination value 701 to calculate a correction value 703 of the front illumination value. The vehicle control apparatus may calculate a result value obtained by applying a first variable reflection ratio 751 to the correction value 703 of the front illumination value.

For example, the vehicle control apparatus may detect brightness above the vehicle by an upper illumination sensor to measure an upper illumination value 702. The vehicle control apparatus may apply a second stabilization process 761 to the upper illumination value 702 to calculate a correction value 704 of the upper illumination value. The vehicle control apparatus may calculate a result value obtained by applying a second variable reflection ratio 771 to the correction value 704 of the upper illumination value.

According to an embodiment, the first variable reflection ratio 751 and the second variable reflection ratio 771 may include a ratio, a ratio value of which varies with a value of a specific variable. For example, the specific variable may include a speed of the vehicle, a distance between the vehicle and a front tunnel, a distance between the vehicle and a front indoor parking lot, or a gradient of a road ahead.

According to an embodiment, the vehicle control apparatus may calculate the final photosensitive brightness 781, based on the result value obtained by applying the first variable reflection ratio 751 to the correction value 703 of the front illumination value and the result value obtained by applying the second variable reflection ratio 771 to the correction value 704 of the upper illumination value.

According to an embodiment, if a difference between the brightness in front of the vehicle and the brightness above the vehicle is greater than a predetermined threshold, the vehicle control apparatus may apply additional weights, which are independent of each other, to the stabilization process or the variable reflection ratio. As a detailed example, the vehicle control apparatus may apply an additional weight to increase the real-time responsiveness to the stabilization process.

For example, the vehicle control apparatus may apply a second additional weight to the second stabilization process 761 to increase a ratio of an upper illumination value measured at a specific time point to a correction value of an upper illumination value calculated before the specific time point.

According to an embodiment, the vehicle control apparatus may apply the first stabilization process 742 to which the additional weight is applied to the front illumination value 701, thus calculating a correction value 705 of the front illumination value to which the additional weight is applied.

For example, the vehicle control apparatus may apply a first additional weight to the first stabilization process 741 to increase a ratio of a front illumination value measured at the specific time point to a correction value of a front illumination value calculated before the specific time point.

According to an embodiment, the vehicle control apparatus may calculate a result value obtained by applying a first variable reflection ratio 752 to which the additional weight is applied to the correction value 705 of the front illumination value to which the additional weight is applied.

For example, if there is a need to increase the proportion of the front illumination 701 with, the vehicle control apparatus may apply an additional weight to only the first variable reflection ratio.

According to an embodiment, the vehicle control apparatus may apply the second stabilization process 762 to which the additional weight is applied to the upper illumination value 702, thus calculating a correction value 706 of an upper illumination value to which the additional weight is applied.

For example, the vehicle control apparatus may apply a second additional weight to the second stabilization process 761 to increase the ratio of an upper illumination value measured at the specific time point to the correction value of an upper illumination value calculated before the specific time point.

According to an embodiment, the vehicle control apparatus may calculate a result value obtained by applying a second variable reflection ratio 772 to which the additional weight is applied to the correction value 706 of the upper illumination value to which the additional weight is applied.

For example, if there is a need to increase the proportion of the upper illumination 702, the vehicle control apparatus may apply an additional weight to only the second variable reflection ratio.

According to an embodiment, the weight applied to the first reflection ratio or the weight applied to the second reflection ratio may be to increase any one of the first variable reflection ratio or the second variable reflection ratio. The additional weight may be applied to only any one of the first variable reflection ratio or the second variable reflection ratio.

According to an embodiment, the vehicle control apparatus may apply at least one of the stabilization process to which the additional weight is applied or the variable reflection ratio to which the additional weight is applied, or any combination thereof to an illumination value measured by a front illumination sensor, thus calculating final photosensitive brightness.

Referring to FIG. 7 according to an embodiment, if the brightness outside the vehicle changes rapidly, the vehicle control apparatus may apply the additional weight to the stabilization process or the variable reflection ratio to quickly measure brightness which changes rapidly.

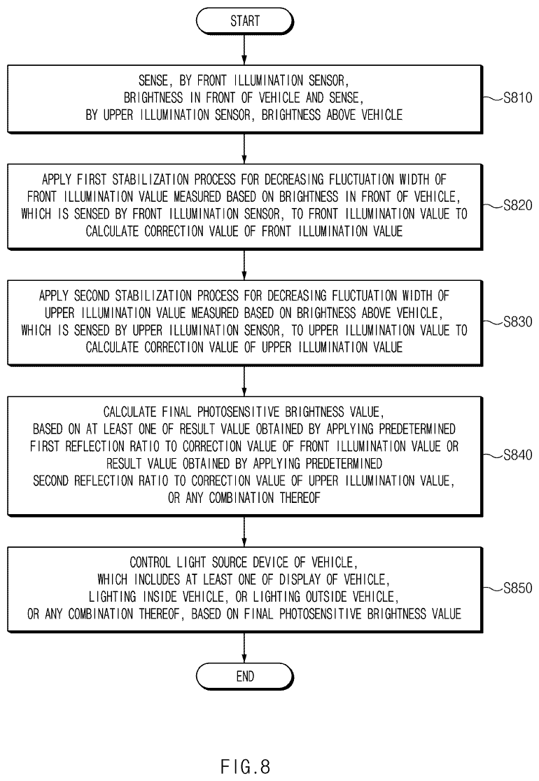

FIG. 8 is a flowchart for describing a vehicle control apparatus or a vehicle control method according to an embodiment of the present disclosure.

Hereinafter, it is assumed that a vehicle control apparatus 100 of FIG. 1 performs a process of FIG. 8. Furthermore, in a description of FIG. 8, an operation described as being performed by a processor may be understood as being controlled by a processor 110 of the vehicle controller 100.

According to an embodiment, in S810, a front illumination sensor may sense brightness in front of a vehicle, and an upper illumination sensor may sense brightness above the vehicle.

According to an embodiment, in S820, the processor may apply a first stabilization process that reduces a fluctuation range of a front illumination value measured based on brightness in front of the vehicle, which is sensed by the front illumination sensor, to the front illumination value to calculate a correction value of the front illumination value.

According to an embodiment, in S830, the processor may apply a second stabilization process that reduces a fluctuation range of an upper illumination value measured based on brightness above the vehicle, which is sensed by the upper illumination sensor, to the upper illumination value to calculate a correction value of the upper illumination value.

According to an embodiment, in S840, the processor may calculate a final photosensitive brightness value, based on at least one of the following: a result value obtained by applying a predetermined first reflection ratio to the correction value of the front illumination value or a result value obtained by applying a predetermined second reflection ratio to the correction value of the upper illumination value, or any combination thereof.

According to an embodiment, in S850, the processor may control a light source device of the vehicle, which includes at least one of a display of the vehicle, lighting inside the vehicle, or lighting outside the vehicle, or any combination thereof, based on the final photosensitive brightness value.

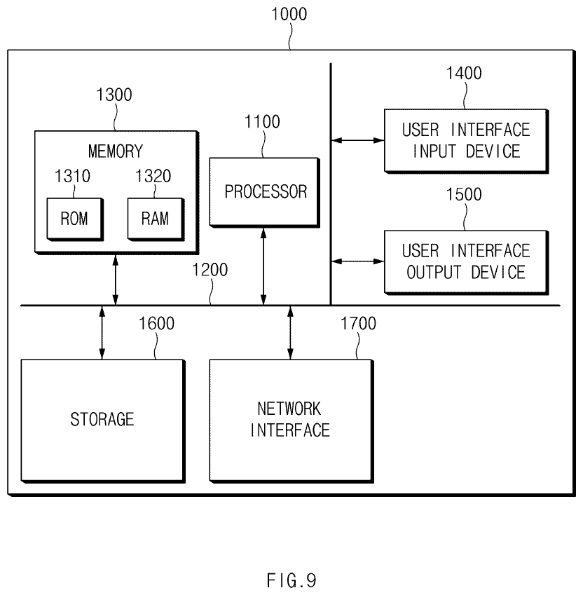

FIG. 9 illustrates a computing system associated with a vehicle control apparatus or a vehicle control method according to an embodiment of the present disclosure.

Referring to FIG. 9, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include aread only memory (ROM) 1310 and arandom access memory (RAM) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The present technology may measure both of illumination in front of the vehicle and illumination above the vehicle to distinguish a difference in brightness according to whether there are street lights during nighttime driving.

Furthermore, the present technology may measure both the illumination in front of the vehicle and the illumination above the vehicle to determine illumination outside the vehicle with regard to an influence according to a color of a forward vehicle and whether the forward vehicle lights up.

Furthermore, the present technology may measure both the illumination in front of the vehicle and the illumination above the vehicle to determine illumination outside the vehicle with regard to the direction facing the front of the vehicle during sunrise or sunset.

Furthermore, the present technology may measure both the illumination in front of the vehicle and the illumination above the vehicle to determine illumination outside the vehicle by considering the difference between illumination at a current position of the vehicle and illumination in a tunnel or a parking lot in front of the vehicle, when the vehicle enters the parking lot or the tunnel.

Furthermore, the present technology may apply a variable weight to illumination in front of the vehicle and illumination above the vehicle to determine illumination outside the vehicle, depending on a driving situation including the speed of the vehicle and the gradient of the road ahead.

Furthermore, the present technology may determine a situation in which illumination outside the vehicle changes greatly, based on the difference between the illumination in front of the vehicle and the illumination above the vehicle.

In addition, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A vehicle control apparatus, comprising:
a front illumination sensor configured to sense brightness in front of a vehicle;
an upper illumination sensor configured to sense brightness above the vehicle;
a memory storing a program instruction; and
a processor configured to execute the program instruction,
wherein the processor is configured to:
calculate a correction value of a front illumination value by applying a first stabilization process that reduces a fluctuation range of the front illumination value measured based on the brightness in front of the vehicle, the brightness being sensed by the front illumination sensor;
calculate a correction value of an upper illumination value by applying a second stabilization process that reduces a fluctuation range of the upper illumination value measured based on the brightness above the vehicle, the brightness being sensed by the upper illumination sensor;
calculate a final photosensitive brightness value, based on at least one of the following: a result value obtained by applying a predetermined first reflection ratio to the correction value of the front illumination value, a result value obtained by applying a predetermined second reflection ratio to the correction value of the upper illumination value, or any combination thereof; and
control a light source device of the vehicle, the light source device comprising at least one of a display of the vehicle, lighting inside the vehicle, or lighting outside the vehicle, or any combination thereof, based on the final photosensitive brightness value.

2. The vehicle control apparatus of claim 1, wherein the first stabilization process comprises a process of calculating a correction value of a front illumination value at a specific time point, based on a result value obtained by applying a predetermined first weight to the front illumination value measured at the specific time point and a result value obtained by applying a predetermined second weight to a correction value of a front illumination value calculated before the specified time point, and
wherein the second stabilization process comprises a process of calculating a correction value of an upper illumination value at the specific time point, based on a result value obtained by applying a predetermined third weight to the upper illumination value measured at the specific time point and a result value obtained by applying a predetermined fourth weight to a correction value of an upper illumination value calculated before the specified time point.

3. The vehicle control apparatus of claim 2, wherein the processor is further configured to:
calculate the correction value of the front illumination value at the specific time point, while maintaining the sum of the first weight and the second weight as a total value of predetermined weights; and
calculate the correction value of the upper illumination value at the specific time point, while maintaining the sum of the third weight and the fourth weight as the total value of predetermined weights.

4. The vehicle control apparatus of claim 1, wherein the processor is further configured to:
calculate the final photosensitive brightness value, while maintaining the sum of the first reflection ratio and the second reflection ratio as a total value of predetermined reflection ratios.

5. The vehicle control apparatus of claim 1, wherein the first reflection ratio comprises a first fixed reflection ratio, a ratio value of which is fixed for each specific situation comprising at least one of daytime driving, nighttime driving on a road with street lights on, nighttime driving on a road without street lights, driving in a tunnel, or driving in an indoor parking lot, or any combination thereof,
wherein the second reflection ratio includes a second fixed reflection ratio, a ratio value of which is fixed for each specific situation, and
wherein the processor is further configured to:
calculate the final photosensitive brightness value, based on at least one of the following: a result value obtained by applying the first fixed reflection ratio to the correction value of the front illumination value or a result value obtained by applying the second fixed reflection ratio to the correction value of the upper illumination value, or any combination thereof.

6. The vehicle control apparatus of claim 1, wherein the first reflection ratio comprises a first variable reflection ratio, a ratio value of which varies with a value of a specific variable including a speed of the vehicle, a distance between the vehicle and a front tunnel, a distance between the vehicle and a front indoor parking lot, a gradient of a road ahead, or a combination thereof,
wherein the second reflection ratio includes a second variable reflection ratio, a ratio value of which varies with the value of the specific variable, and
wherein the processor is further configured to:
calculate the final photosensitive brightness value, based on at least one of the following: a result value obtained by applying the first variable reflection ratio to the correction value of the front illumination value or a result value obtained by applying the second variable reflection ratio to the correction value of the upper illumination value, or any combination thereof.

7. The vehicle control apparatus of claim 2, wherein the processor is further configured to:
while the vehicle is traveling,
if a difference between the brightness in front of the vehicle and the brightness above the vehicle is greater than a predetermined threshold:
apply a first additional weight to the first stabilization process to increase a ratio of the front illumination value measured at the specific time point to the correction value of the front illumination value calculated before the specific time point; or
apply a second additional weight to the second stabilization process to increase a ratio of the upper illumination value measured at the specific time point to the correction value of the upper illumination value calculated before the specific time point.

8. The vehicle control apparatus of claim 1, wherein the processor is further configured to:
while the vehicle is traveling,
if a difference between the brightness in front of the vehicle and the brightness above the vehicle is greater than a predetermined threshold:
apply at least one weight to any one of the first reflection ratio or the second reflection ratio.

9. The vehicle control apparatus of claim 1, wherein the processor is further configured to:
change at least one of the first stabilization process, the second stabilization process, the first reflection ratio, or the second reflection ratio, or any combination thereof, depending on a time zone, and calculate the final photosensitive brightness value.

10. The vehicle control apparatus of claim 9, wherein the first reflection ratio comprises:
a first variable reflection ratio, a ratio value of which varies with a value of a specific variable including a speed of the vehicle, a distance between the vehicle and a front tunnel, a distance between the vehicle and a front indoor parking lot, or a gradient of a road ahead,
wherein the second reflection ratio includes a second variable reflection ratio, a ratio value of which varies with the value of the specific variable, and
wherein the processor is further configured to:
calculate the final photosensitive brightness value, based on at least one of the following: a result value obtained by applying the first variable reflection ratio to the correction value of the front illumination value or a result value obtained by applying the second variable reflection ratio to the correction value of the upper illumination value, or any combination thereof.

11. The vehicle control apparatus of claim 9, wherein the first reflection ratio comprises:
a first fixed reflection ratio, a ratio value of which is fixed for each specific situation including at least one of daytime driving, nighttime driving on a road with street lights on, nighttime driving on a road without street lights, driving in a tunnel, or driving in an indoor parking lot, or any combination thereof,
wherein the second reflection ratio comprises a second fixed reflection ratio, a ratio value of which is fixed for each specific situation, and
wherein the processor is further configured to:
calculate the final photosensitive brightness value, based on at least one of the following: a result value obtained by applying the first fixed reflection ratio to the correction value of the front illumination value or a result value obtained by applying the second fixed reflection ratio to the correction value of the upper illumination value, or any combination thereof.

12. The vehicle control apparatus of claim 1, wherein the first stabilization process comprises:
a process of calculating the correction value of the front illumination value, based on a simple moving average (SMA) technique for calculating an arithmetic mean value of front illumination values measured during a specific duration; or
a process of calculating the correction value of the front illumination value, based on an exponential moving average (EMA) technique for assigning a greater weight to a front illumination value measured recently among the front illumination values measured during the specific duration and calculating an average value of the front illumination values measured during the specific duration, and
wherein the second stabilization process comprises:
a process of calculating the correction value of the upper illumination value, based on the SMA technique for calculating an arithmetic mean value of upper illumination values measured during the specific duration; or
a process of calculating the correction value of the upper illumination value, based on the EMA technique for assigning a greater weight to an upper illumination value measured recently among the upper illumination values measured during the specific duration and calculating an average value of the upper illumination values measured during the specific duration.

13. A vehicle control method, comprising:
sensing, by a front illumination sensor, brightness in front of a vehicle;
sensing, by an upper illumination sensor, brightness above the vehicle;
calculating, by a processor, a correction value of a front illumination value by applying a first stabilization process that reduces a fluctuation range of the front illumination value measured based on the brightness in front of the vehicle, the brightness being sensed by the front illumination sensor;
calculating, by a processor, a correction value of an upper illumination value by applying a second stabilization process that reduces a fluctuation range of the upper illumination value measured based on the brightness above the vehicle, the brightness being sensed by the upper illumination sensor;
calculating, by the processor, a final photosensitive brightness value, based on at least one of the following: a result value obtained by applying a predetermined first reflection ratio to the correction value of the front illumination value or a result value obtained by applying a predetermined second reflection ratio to the correction value of the upper illumination value, or any combination thereof; and
controlling, by the processor, a light source device of the vehicle, the light source device including at least one of a display of the vehicle, lighting inside the vehicle, or lighting outside the vehicle, or any combination thereof, based on the final photosensitive brightness value.

14. The vehicle control method of claim 13, wherein the applying the first stabilization process comprises:
calculating, by the processor, a correction value of a front illumination value at a specific time point, based on a result value obtained by applying a predetermined first weight to the front illumination value measured at the specific time point and a result value obtained by applying a predetermined second weight to a correction value of a front illumination value calculated before the specified time point, and
wherein the applying the second stabilization process comprises:
calculating, by the processor, a correction value of an upper illumination value at the specific time point, based on a result value obtained by applying a predetermined third weight to the upper illumination value measured at the specific time point and a result value obtained by applying a predetermined fourth weight to a correction value of an upper illumination value calculated before the specified time point.

15. The vehicle control method of claim 13, wherein the calculating the final photosensitive brightness value comprises:
calculating, by the processor, the final photosensitive brightness value, based on at least one of the following: a result value obtained by applying a first fixed reflection ratio to the correction value of the front illumination value or a result value obtained by applying a second fixed reflection ratio to the correction value of the upper illumination value, or any combination thereof,
wherein the first reflection ratio comprises the first fixed reflection ratio, a ratio value of which is fixed for each specific situation including at least one of daytime driving, nighttime driving on a road with street lights on, nighttime driving on a road without street lights, driving in a tunnel, or driving in an indoor parking lot, or any combination thereof, and
wherein the second reflection ratio comprises the second fixed reflection ratio, a ratio value of which is fixed for each specific situation.

16. The vehicle control method of claim 13, wherein the calculating the final photosensitive brightness value comprises:
calculating, by the processor, the final photosensitive brightness value, based on at least one of the following: a result value obtained by applying a first variable reflection ratio to the correction value of the front illumination value or a result value obtained by applying a second variable reflection ratio to the correction value of the upper illumination value, or any combination thereof,
wherein the first reflection ratio comprises the first variable reflection ratio, a ratio value of which varies with a value of a specific variable comprising a speed of the vehicle, a distance between the vehicle and a front tunnel, a distance between the vehicle and a front indoor parking lot, or a gradient of a road ahead, and
wherein the second reflection ratio comprises the second variable reflection ratio, a ratio value of which varies with the value of the specific variable.

17. The vehicle control method of claim 14, wherein the applying the first stabilization process range comprises:
applying, by the processor, a first additional weight to the first stabilization process to increase a ratio of the front illumination value measured at the specific time point to the correction value of the front illumination value calculated before the specific time point, if a difference between the brightness in front of the vehicle and the brightness above the vehicle is greater than a predetermined threshold, while the vehicle is traveling, and
wherein the applying the second stabilization process range comprises:
applying, by the processor, a second additional weight to the second stabilization process to increase a ratio of the upper illumination value measured at the specific time point to the correction value of the upper illumination value calculated before the specific time point, if the difference between the brightness in front of the vehicle and the brightness above the vehicle is greater than the predetermined threshold, while the vehicle is traveling.

18. The vehicle control method of claim 13, wherein the calculating the final photosensitive brightness value comprises:
applying, by the processor, at least one weight to any one of the first reflection ratio or the second reflection ratio, if a difference between the brightness in front of the vehicle and the brightness above the vehicle is greater than a predetermined threshold, while the vehicle traveling.

19. The vehicle control method of claim 13, wherein the calculating the final photosensitive brightness value comprises:
changing, by the processor, at least one of the first stabilization process, the second stabilization process, the first reflection ratio, or the second reflection ratio, or any combination thereof, depending on a time zone, and calculating, by the processor, the final photosensitive brightness value.

20. The vehicle control method of claim 13, wherein the applying the first stabilization process comprises:
calculating, by the processor, the correction value of the front illumination, based on a simple moving average (SMA) technique for calculating an arithmetic mean value of front illumination values measured during a specific duration; or
calculating the correction value of the front illumination value, based on an exponential moving average (EMA) technique for assigning a greater weight to a front illumination value measured recently among the front illumination values measured during the specific duration and calculating an average value of the front illumination values measured during the specific duration, and
wherein the applying the second stabilization process comprises:
calculating, by the processor, the correction value of the upper illumination, based on the SMA technique for calculating an arithmetic mean value of upper illumination values measured during the specific duration; or
calculating, by the processor, the correction value of the upper illumination value, based on the EMA technique for assigning a greater weight to an upper illumination value measured recently among the upper illumination values measured during the specific duration and calculating an average value of the upper illumination values measured during the specific duration.
